(19) United States
(12) Patent Application Publication
(10) Pub. No.: US 2019/0107174 A1
(43) Pub. Date: Apr. 11, 2019

(54) CORD CONNECTOR

(71) Applicant: Aqua Lung America, Inc., Vista, CA (US)

(72) Inventors: David SULLIVAN, Vista, CA (US); Eric THORSTENSON, Vista, CA (US)

(21) Appl. No.: 16/155,677

(22) Filed: Oct. 9, 2018

Related U.S. Application Data
(60) Provisional application No. 62/570,005, filed on Oct. 9, 2017.

(51) Int. Cl. F16G 11/10; F16G 11/12

(52) U.S. Cl. CPC F16G 11/10; F16G 11/12

(57) ABSTRACT

This disclosure relates to a modular cord connector that enables two cords to connect together and release. An embodiment of this cord connector disclosure is designed for use on cords integral to a gas release on buoyancy compensator devices. The preferred embodiment of this cord connector, shown for use on a buoyancy compensator device, includes modular male and female portions which include a T-shaped post on the male portion and a pathway with detents configured to retain the male portion when engaged with the female portion.

### CROSS-REFERENCE TO RELATED APPLICATIONS

This application claims the benefit under 35 U.S.C. § 119(e) of the following U.S. provisional patent application, which is incorporated by reference herein:

U.S. Provisional Patent Application 62/570,005, filed Oct. 9, 2017, and entitled “SYSTEMS AND DEVICES INCORPORATING A NOVEL MODULAR CONNECTOR,” by Sullivan et al. (Attorney Docket 239717.000172.ALUNG26PRV).

### FIELD OF THE INVENTION

This disclosure relates to an embodiment of a cord connector device designed for use in sporting goods such as underwater operations on swimming and diving gear.

### BACKGROUND

Modern buoyancy compensator device designs utilize a valve for releasing gas contained within the buoyancy compensating air chamber. Furthermore, modern buoyancy compensators employ various means to remotely activate these gas release valves for both ergonomic and safety reasons. The most common means of remote activation of the gas release valve is by means of a cord and pull knob. Depending on the construction of the buoyancy compensator, a separable element in the cord is required. While quick-release buckles or hook and loop fasteners are commonly used when a quick-release element is needed on sporting equipment, there are disadvantages relating to buckles or hook and loop fasteners when used for separating remote means of actuating gas release valves.

Hook and loop fasteners have disadvantages because they lose strength when wet, when contaminated by sand or other debris, or when they age. Further detrimental to the feasibility of using hook and loop fasteners is their inherent bulk, risking safety concerns by the possibility of becoming stuck on an underwater object and causing the inadvertent actuation and subsequent release of gas from the buoyancy chamber.

Quick-release buckles are commonly used underwater, but typically add significant bulk and, as such, pose a similar safety concern to using hook and loop fasteners.

Accordingly, it is an objective of this disclosure is to provide an embodiment of a modular connector that may be used on a buoyancy compensator gas release device which eliminates the disadvantages of previous connectors and fasteners.

### SUMMARY

A modular cord connector is provided which includes a male portion, having opposite ends and an aperture within one end. It must be noted that within the scope of this invention a cord is considered any object or material substantially longer than its cross section and possessing a significant amount of flexibility. A cord is attached to the male portion and defines a cord axis when the cord is pulled through the aperture. A knot may be formed in the cord to keep it from pulling through the aperture and retaining the cord on the male portion. The male portion includes an enlarged chamber in communication with the aperture which at least partially covers the end of the cord which is typically arranged into a knot. The male portion also includes a post perpendicular to the cord axis. The post on the male portion may be T-shaped. A female portion is included with opposite ends and has an aperture within one end. The female portion includes an enlarged chamber in communication with the aperture which at least partially covers the end of the cord, also typically arranged into a knot. The female portion includes a pathway into which the male portion is inserted. This pathway may be an extension of the aforementioned enlarged chamber or it may be entirely separate. The pathway may also be along the axis of the cord. The female portion includes raised areas on the pathway forming detents which provide resistance to removal of the connection when the male portion is inserted into the female portion. When the male portion is engaged with the female portion, the detents formed in the female portion prevent removal of the male portion from the female portion. The modular cord connector may also include a shield attached to the female portion and which covers the end of the cord in the male portion when the male and female portions are connected.

One popular embodiment is a mechanism in the location of the upper right portion of the air chamber of the buoyancy chamber for the gas release. For buoyancy compensator designs that require the remote actuation portion of the gas release valve to be separable, the means of actuation such as a cord must be secured for safety. The portion of the cord most remote from the gas release valve may be slidingly, but non-removably, secured to one portion of the buoyancy compensator, such as a shoulder. The modular cord connector thus connects the cord portion secured to, for example, the shoulder to the cord portion secured to the gas release valve of the air chamber. Thus, the shoulder portion may be easily and simply removed from the buoyancy compensator allowing for repair, replacement, or upgrade.

### BRIEF DESCRIPTION OF THE DRAWINGS

FIG. 1 is side perspective view of one embodiment of the male portion of a modular cord connector.

FIG. 2 is a side view of one embodiment of the female portion of a modular cord connector.

FIG. 3 is an interior view of the female portion of a modular cord connector of

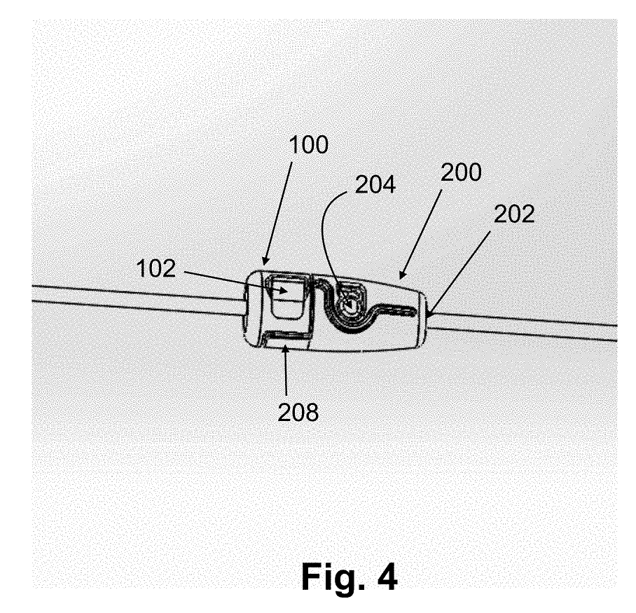

FIG. 2.

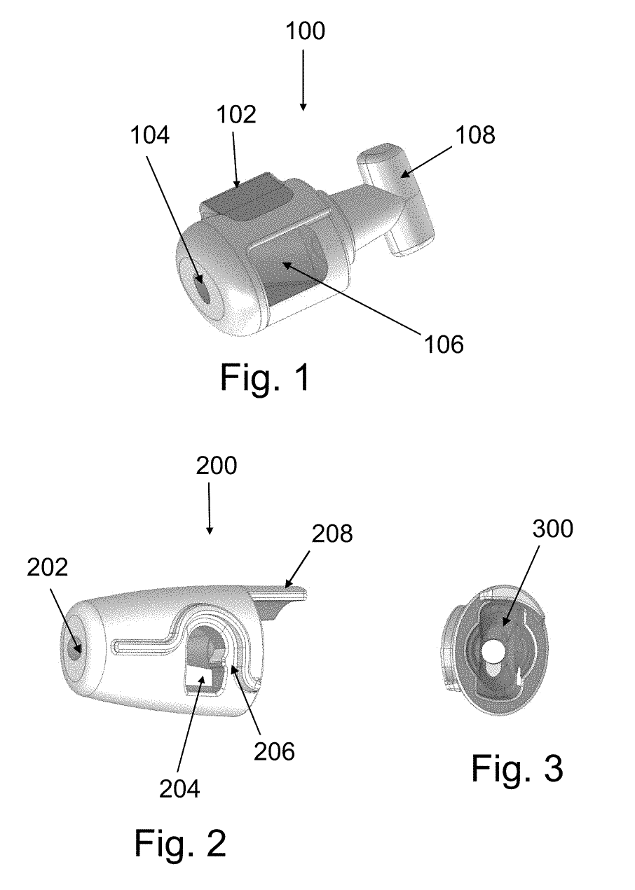

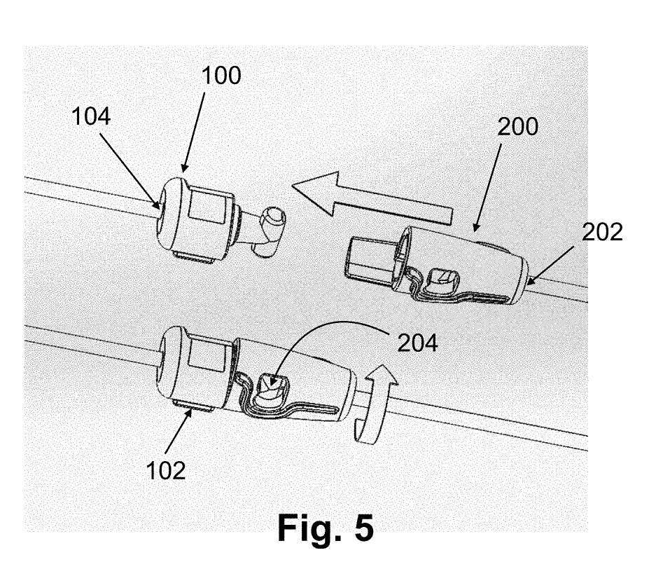

FIG. 4 is a view showing the connection of the male and female portions of the modular cord connector of FIGS. 1-3, and associated cord portions.

FIG. 5 is a series of images showing a preferred embodiment of the method of assembling the male and female portions of the modular cord connector

### DETAILED DESCRIPTION

Referring to FIGS. 1-3, the modular cord connector is comprised of a male portion (100) and a female portion (200). A cord is provided to be attached to a desired device for operation or use and a second cord may be provided for the purposes of further remote actuation of the desired device. It should be appreciated that certain embodiments may include one cord, with the male portion (100) and the female portion (200) attached to each end of the cord. The cord defines a cord axis which is the line that the cord traces when the ends are pulled taught. Both the male (100) and female (200) portions of the component have an aperture (104, 202) in one end of each portion. The male portion (100) includes an enlarged chamber (106), and female portion (200) includes a pathway (300) along the cord axis. The male portion (100) can be inserted into female portion (200), shown in FIGS. 1-4. Chamber (106) and pathway (300) allow a knot to be tied in the cord then the free end of the cord fed through the aperture (104 and 202 respectively). The chamber covers the knot and the transition between the chamber and hole creates a shelf that interferes with the knot and retains the cord in the connector. The male portion has at least one post (108) perpendicular to the cord axis.

The female portion has a cutout (204) that in combination with the pathway (300) allow the post of the male portion to be inserted along the cord axis then rotated about the cord axis. Detents (206) are provided in the female portion (200) to allow an interference fit with the male post (108) providing resistance to and an increase in the pressure necessary to rotate the male portion (100) with respect to female portion (200). Such resistance helps prevent unintended rotation and thus maintains the connection of the male portion (100) and female portion (200) together. Further aspects of this modular connector include a shield extension (208) associated with the female portion that, when the male and female portions are connected together aesthetically covers the enlarged chamber (106) in the male, as well as a raised shelf (102) on the male portion to make it easier for the user to grasp and twist the connectors when disassembling. Although the attachment method described is the preferred embodiment, other axes of rotation to engage the detents in the female, such as rotation perpendicular to the cord axis and similar rotation configurations are equally viable.

One use of the disclosed modular cord connector is on buoyancy compensation devices requiring release of air, gas or the like for proper operation. In an embodiment of a buoyancy compensator device that includes a detachable shoulder or air cell component, a modular cord connector is needed to maintain the popular feature of a remote gas release mechanism in the location of the right shoulder. The preferred embodiment of the disclosed cord connector on a buoyancy compensator device is made of plastic, which is resistant to water and other elemental damage.

In an embodiment where the cord is used on a buoyance compensator device that is equipped with an upper right air chamber gas release feature, the gas release feature is equipped with the mating portion of the cord lock modular component allowing the cord portion to securely slide to the shoulder to be in tensile communication with the cord portion of the air chamber.

Reference throughout this specification to “the embodiment,” “this embodiment,” “the previous embodiment,” “one embodiment,” “an embodiment,” “a preferred embodiment” “another preferred embodiment” or similar language means that a particular feature, structure, or characteristic described in connection with the embodiment is included in at least one embodiment of the present invention. Thus, appearances of the phrases “in the embodiment, “in this embodiment,” “in the previous embodiment, in one embodiment, in an embodiment,” “in a preferred embodiment,” “in another preferred embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. While the present invention has been described in connection with certain exemplary or specific embodiments, it is to be understood that the invention is not limited to the disclosed embodiments, but, on the contrary, is intended to cover various modifications, alternatives, modifications and equivalent arrangement as will be apparent to those skilled in the art. Any such changes, modifications, alternative, equivalents and the like may be made without departing from the spirit and scope of the disclosure.

What is claimed is:

1. A modular cord connector comprising:
a male portion, having opposite ends and an aperture within one end, a cord for attachment to the male portion and defining a cord axis when the cord is pulled through the aperture, an enlarged chamber in communication with the aperture which at least partially covers the end of the cord, and a post perpendicular to the cord axis; and
a female portion, having opposite ends and an aperture within one end, the cord being attached to the female portion, and the female portion having an enlarged chamber in communication with the aperture which at least partially covers the end of the cord, and a pathway into which the male portion is inserted.

2. The modular cord connector of claim 1 wherein the pathway is along the cord axis.

3. The modular cord connector of claim 1 further including a first cord and a second cord, wherein the male portion is connected to the first cord and the female portion is connected to the second cord.

4. The modular cord connector of claim 2 wherein the post is T-shaped.

5. The modular cord connector of claim 2 further including raised areas on the pathway of the female portion forming detents providing resistance to removal when the male portion is inserted into the female portion.

6. The modular cord connector of claim 2 wherein the male portion in engaged with the female portion and the detents formed in the female portion prevent removal of the male portion from the female portion upon engagement.

7. The modular cord connector of claim 2 further including a shield attached to the female portion which covers the end of the cord in the male portion when the male portion and female portion are connected.

8. The modular cord connector of claim 3 wherein the post is T-shaped.

9. The modular cord connector of claim 3 further including raised areas on the pathway of the female portion forming detents providing resistance to removal when the male portion is inserted into the female portion.

10. The modular cord connector of claim 3 wherein the male portion in engaged with the female portion and the detents formed in the female portion prevent removal of the male portion from the female portion upon engagement.

11. The modular cord connector of claim 3 further including a shield attached to the female portion which covers the end of the cord in the male portion when the male portion and female portion are connected.
